(19) United States
(12) Patent Application Publication
(10) Pub. No.: US 2024/0367623 A1
(43) Pub. Date: Nov. 7, 2024

(54) ELECTRIC VEHICLE WITH AT LEAST ONE BRAKING SYSTEM AND METHOD FOR OPERATING AN ELECTRIC VEHICLE

(71) Applicant: ZF FRIEDRICHSHAFEN AG, Friedrichshafen (DE)

(72) Inventors: Matthias MÜLLER-LINKOWITSCH, Horgenzell (DE); Daniel MARTIN, Friedrichshafen (DE); Christian SIBLA, Wasserburg (DE); Wolfgang BARTH, Meckenbeuren (DE)

(21) Appl. No.: 18/686,071

(22) PCT Filed: Aug. 30, 2022
(86) PCT No.: PCT/EP2022/074073

§ 371 Date: Feb. 23, 2024

(30) Foreign Application Priority Data
Aug. 30, 2021 (DE) 10 2021 209 488.0

(51) Int. Cl. B60T 1/06

(52) U.S. Cl. CPC B60T 1/062

(57) ABSTRACT

An electric vehicle with at least one brake system and an axle and a method to operate the electric vehicle. The at least one brake system is arranged at the axle and includes a wet service brake, a parking brake, and an actuator. The actuator is adjustable and can communicate with a service brake in a service brake region or with the parking brake in a securing region to generate a braking action at the axle in each instance. A neutral region in which the actuator communicates neither with the service brake nor with the parking brake is located between the service brake region and the securing region. A plurality of brake systems are advantageously used jointly in the various configurations.

### CROSS REFERENCE TO RELATED APPLICATIONS

This is a U.S. national stage of Application No. PCT/EP2022/074073 filed Aug. 30, 2022. Priority is claimed on German Application No. DE 10 2021 209 488.0 filed Aug. 30, 2021, the content of which is incorporated herein by reference.

### BACKGROUND OF THE INVENTION

### 1. Field of the Invention

The disclosure is directed to a brake system for an electric vehicle that has both a wet service brake and a parking brake.

### 2. Description of the Related Art

Primarily drum brakes and disk brakes are used as service brakes for electric vehicles and are generally installed individually at each driving wheel of the vehicle. Both variants utilize brake shoes which, when activated, are pressed on a surface that is fixedly connected to one of the drive wheels and moves with the latter. As a result of friction, a countertorque is generated relative to a movement of the drive wheel and the electric vehicle is braked in this way.

A special type of disk brake is the oil bath brake, also known as a wet service brake or a wet brake, in which one or more brake disks rotate in an oil bath. The brake disks are pressed against intermediate disks located between the brake disks by pressure plates when the brake is activated, so that the friction between the brake disks, intermediate disks and pressure plates produces a braking torque. In the most common construction, the pressure plates are rotated relative to one another from the outside by an actuator. Balls are supported between the pressure plates in elongate, continuously flattening depressions and can move the pressure plates apart or toward one another. Since the entire surface of the brake disks contributes to the generation of the braking torque, this type of brake is called a full-disk brake or multidisk brake. These brakes are advantageous because of the integrated cooling, the fact that they are maintenance-free in that soiling is prevented by the closed construction, and because abrasion is reduced at the brake disks by the oil bath and heat is conducted away.

In addition to the service brake, electric vehicles have a parking brake or emergency brake with which the wheels can be locked. This parking brake is activated by cable pulls or electrically and works independent from the service brake.

A brake system with a multidisk brake as service brake and parking brake is known from DE 10 2006 012 065 A1. In this case, a modularly constructed brake module is disclosed for a drive axle. This brake module is arranged in a brake housing between an axle bracket and a center part of the drive axle. The multidisk brake is actuated hydraulically as both service brake and parking brake but with separate hydraulic circuits. To activate the service brake, a piston is pressed directly onto the multidisk brake. The service brake is disengaged, for example, by spring force. The parking brake is constructed as a negative brake so that when the pressure in its respective hydraulic circuit is reduced, it moves, e.g., by spring force, in direction of the piston of the service brake which then secures the multidisk brake via the piston.

The disadvantage in such a solution consists in that wet multidisk brakes have microslip so that it is not possible to park the vehicle on an incline for a very long period of time.

### SUMMARY OF THE INVENTION

It is an object of one aspect of the invention to provide an electric vehicle with a brake system having a wet brake, which brake system is compact enough that it can be individually mounted on every drive wheel or at an associated driveshaft and which, further, can also reliably secure the electric vehicle on inclines.

One aspect of the invention is an electric vehicle with at least one brake system. The electric vehicle has an axle, and the at least one brake system is arranged at the axle and comprises a frictionally engaging wet service brake, a positively engaging parking brake and an actuator. The actuator is adjustable between a service brake region within which it communicates with the service brake, a securing region within which it communicates with the parking brake, and a neutral region situated between the service brake region and the securing region within which the actuator communicates neither with the service brake nor with the parking brake.

In an advantageous configuration, the at least one brake system is arranged between a differential and a transmission stage of the axle of the electric vehicle. In this way, it can be provided compactly at every drive wheel of a driven axle of the electric vehicle.

In the neutral region when neither the service brake nor the parking brake communicates with the actuator and the axle can accordingly freely rotate, it is advantageous when the electric vehicle comprises an electric machine having a sensor and communicating with the axle. The sensor makes it possible to detect an unintended rolling of the electric vehicle so that, in response to the rolling, a countertorque which opposes the rolling can be generated by the electric machine.

It is further advantageous when the axle of the electric vehicle is a front axle and the electric vehicle further has a rear axle, the front axle and rear axle comprising in each instance exactly one brake system, the two brake systems being arranged diagonally at the electric vehicle. This construction reduces cost and weight compared with other constructions.

Alternatively, it is advantageous when the axle is a front axle and the electric vehicle further has a rear axle, and the front axle and rear axle comprise in each instance exactly two brake systems. The electric vehicle can be secured in a particularly reliable manner in this way.

One aspect of the invention is to provide a method for operating an electric vehicle by which the electric vehicle is reliably secured on inclines.

A method, according to one aspect of the invention, for operating an electric vehicle Includes, in a first step, an electric vehicle with an axle is made available, a brake system with a frictionally engaging wet service brake and a positively engaging parking brake is associated with the axle, and an actuator communicates with the parking brake. In a second step, the connection of the actuator to the parking brake is canceled in that the actuator is moved from a securing region to a neutral region in which no braking torque acts on the axle. When the electric vehicle is stopped following an acceleration of the electric vehicle, the actuator is moved from the neutral region into the service brake region and enters into communication with the service brake so that the service brake generates a braking torque at the axle. In a final step, the electric vehicle is secured in that the actuator is moved from the service brake region through the neutral region to the securing region and enters into communication with the parking brake so that the axle is secured by the parking brake.

Since the axle is freely movable in the neutral region, a further wet service brake located at the axle carries out additional method steps in an advantageous embodiment of the method for operating an electric vehicle. Accordingly, a cooperation first takes place when the electric vehicle is stopped in that the further service brake communicates with a further actuator when stopping the electric vehicle, so that a braking action is generated at the axle by the further service brake. Maintaining the braking action by the further service brake while the actuator moves from the service brake region through the neutral region to the securing region with the electric vehicle secured makes it possible to secure the axle as the actuator is moved through the neutral region. The connection of the further actuator to the further service brake is subsequently canceled in that the further actuator is moved from a further service brake region into a further neutral region after the actuator has entered into communication with the parking brake so that the axle is secured by the parking brake. In this way, the axle is at no time unbraked.

A further particularly preferred configuration is achieved that allows the axle to be secured in a particularly reliable manner when the further actuator is moved from a further service brake region toward a further securing region during the release of the axle and enters into communication with a further parking brake so that the axle is additionally secured by the further parking brake.

In a further particularly advantageous configuration, the further actuator is moved into the further service brake region before cancellation of the connection of the actuator to the parking brake and enters into communication with the further service brake so that the further service brake generates a braking action at the axle. The subsequent movement of the further actuator into the further neutral region after the actuator has been moved into the neutral region when the connection between the actuator and the parking brake is canceled allows the parking brake to be disengaged without temporarily putting the axle into an unbraked state.

A further advantageous configuration prevents an unwanted rolling of the electric vehicle when the cancellation of the connection of the actuator to the parking brake is detected. To this end, a countertorque is generated that acts on the axle and opposes the unwanted rolling. The countertorque can be applied, for example, via an electric drive machine.

It is likewise advantageous to generate a compensating torque that acts on the axle and compensates a disengagement force which occurs when the connection of the actuator to the parking brake is canceled.

It will be understood that the features mentioned above and those yet to be explained below may be used not only in the stated combinations but also in other combinations or alone without departing from the scope of the present invention.

### BRIEF DESCRIPTION OF THE DRAWINGS

The invention will be explained in more detail in the following with the aid of examples with reference to drawings which also disclose key features of the invention. These examples are provided merely to be illustrative and should not be considered as limiting. For example, a description of an embodiment example having a plurality of elements or components should not be interpreted to mean that all of these elements or components are necessary for its implementation. On the contrary, other embodiment examples may also contain alternative elements and components, fewer elements or components, or additional elements or components. Elements or components of different embodiment examples can be combined with one another unless otherwise stated. Modifications and alterations which are described for one of the embodiment examples may also be applicable to other embodiment examples. Like or comparable elements in the various figures are designated by the same reference numerals and not mentioned repeatedly so as to prevent repetition. The drawings show:

FIG. 1 is a schematic diagram of a drivetrain of an electric vehicle having a brake system;

FIG. 2 is a schematic diagram of a drivetrain of an electric vehicle having a brake system;

FIG. 3 is a diagram of the operating regions of the actuator; and

FIG. 4 is a schematic diagram of the electric vehicle.

### DETAILED DESCRIPTION OF THE PRESENTLY PREFERRED EMBODIMENTS

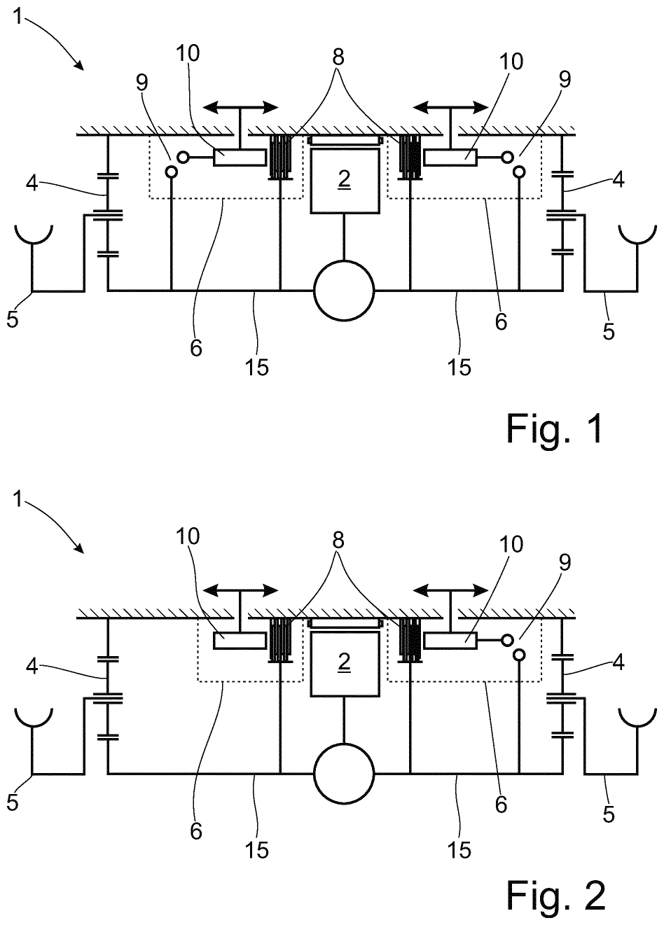

FIG. 1 shows a drivetrain 1 of the electric vehicle according to one aspect of the invention, which drivetrain 1 comprises an electric machine 2 that generates a torque that is transmitted via a differential 3 to an axle, in this instance, a front axle 15, and subsequently, via a transmission stage 4, to the drive wheels 5. To this end, the electric machine 2 comprises one or more electric motors, which represent the sole drive or may also operate as part of a hybrid drive. The electric machine 2 further comprises all of the necessary electronics for controlling and operating necessary or optional sensor arrangements.

A brake assembly is located on each side of the differential 3 at the front axle 15. The brake assembly has a brake housing 6 in which a brake is provided which can decelerate the electric vehicle by generating a braking torque. In this first embodiment, a brake system, which is identical with respect to construction, is located in each instance in both brake housings 6. This brake system comprises a parking brake 9, a service brake 8 and an electromechanically controlled actuator 10 arranged to be movable between the parking brake 9 and the service brake 8.

The service brake 8 is constructed as a wet brake so that, in this instance, the braking torque can be generated via a frictional engagement. Any of the well-known wet service brakes 8 can be applied in the present case as long as it can be actuated by the actuator 10 which is adapted to the respective configuration in a manner familiar to the person skilled in the art.

The parking brake 9 works by a positive engagement so that it is capable of locking the front axle 15. Various configurations will also be apparent from the prior art, for example, parking brakes 9 which produce a positive engagement by claws, piston, bayonet, or crown spline. Also, the parking brake 9 can be activated via the actuator 10 in this case. Parking brake 9 can be provided as a separate component, or the actuator 10 itself operates as part of the parking brake 9 in that it produces a positive engagement with the brake housing 6 and the front axle 15, a part, not shown, fixedly connected to the front axle 15, or one of the transmission stages 4 of the electric vehicle. The brake system can also be located at a rear axle 16, which will be described in more detail later.

FIG. 2 shows an aspect of the drivetrain. In this case, the brake assemblies are formed differently on each side of the differential 3. Depending on the type of electric vehicle, it may be sufficient to provide a brake housing 6 with brake system comprising wet service brake 8, actuator 10, and parking brake 9 on only one side of the front axle 15. A brake housing 6 is located on the side of the front axle 15 opposite the brake system, which brake housing 6 comprises a further service brake 8 which can be activated by a further actuator 10. The second configuration differs from the first configuration in that the further parking brake 9 is absent. Although a first configuration and second configuration of the drivetrain of the electric car are shown, i.e., the front axle 15 is driven in both cases, one or both brake systems may also be applied to non-driven axles. The brake system can also be located at a rear axle 16, which will be described in more detail later.

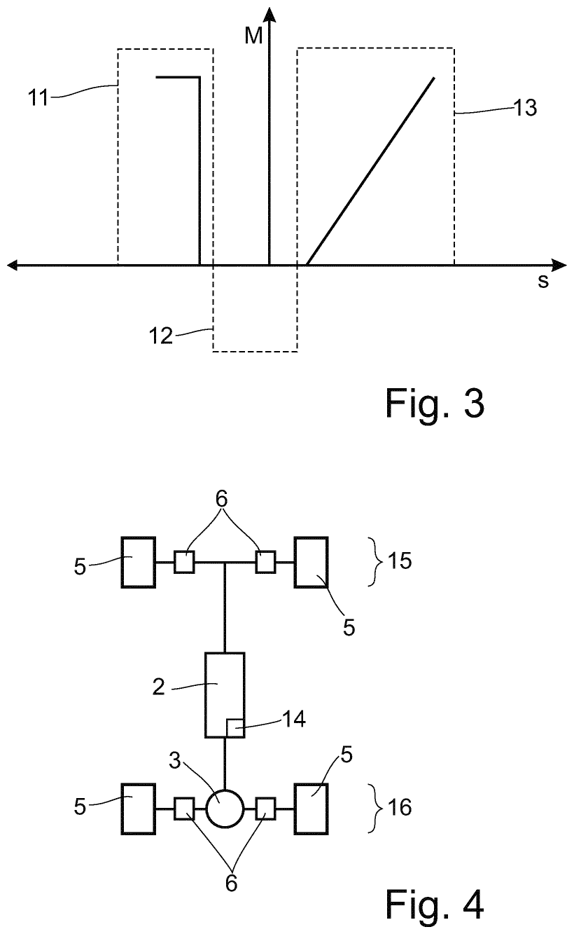

The manner of operation of the actuator 10 and the cooperation of the latter with the service brake 8 and parking brake 9 will now be described referring to FIG. 3, which shows a diagram illustrating the braking action M generated by the service brake 8 and parking brake 9 over the position s of the actuator 10.

The brake system has a service brake region 13 within which the actuator 10 communicates with the service brake 8. In this region, a change in the position s of the actuator 10 brings about a variation in the braking action M. This braking action M increases toward a maximum the farther the position s of the actuator 10 is from an adjoining neutral region 12. In the neutral region 12, the actuator 10 no longer communicates with the service brake 8, so that the service brake 8 does not generate any braking action M. With increasing distance of the position s of the actuator 10 from the service brake region 13, the actuator 10 reaches a securing region 11 in which it communicates with the parking brake 9. The braking action M describes a step in this instance, since a locking or securing of the front axle 15 at which the brake system is located is brought about by the positive engagement.

FIG. 4 shows a schematic diagram of the electric vehicle in its entirety, on the basis of which the arrangement of the brake systems at the electric vehicle will be explained. The electric vehicle has two axles, a front axle 15 and a rear axle 16, which comprise in each instance two drive wheels 5. A brake assembly with a brake located in a brake housing 6 is provided for each drive wheel 5.

In this regard, there are various possibilities for configuring the brakes at the electric vehicle. For example, the front axle 15 and the rear axle 16 can each comprise exactly one brake system, and the two brake systems are arranged diagonally at the electric vehicle. Accordingly, if a brake system is provided on the right-hand side at the front axle 15, a further brake system is located on the left-hand side of the rear axle 16, or vice versa. A further service brake 8 is then located in the brake housing 6 on the side of the respective axle opposite the brake system and the further brake system. However, this can also be entirely omitted depending on the configuration of the electric vehicle.

It is further possible that one of the two axles or both the front axle 15 and the rear axle 16 have two brake systems.

The electric machine 2 is arranged, in this case, as mid-engine, between the front axle 15 and the rear axle 16 and drives the rear axle 16 via the differential 3. According to one aspect of the invention, however, a front wheel drive can be provided in which the differential 3 is located at the front axle 15 or an all-wheel drive can be provided in which either two axles can have a differential 3 in each instance. Alternatively, the drive wheels 5 of the front axle 15 or of the rear axle 16 or of both axles can be driven individually. Depending on the construction, the differential 3 can possibly be dispensed with and replaced by an axle bracket. Corresponding solutions are sufficiently known from the prior art. In general, it is immaterial for the brake system according to the invention whether the axle at which it is located has a drive or is passive. However, a driven axle may be advantageous for certain constructions.

In particular, a characteristic of the electric vehicle according to one aspect of the invention consists in that the installed brake system, depending on the construction, releases the drive wheels 5 when the actuator 10 is in the neutral region 12. An unwanted rolling of the electric vehicle can come about precisely when disengaging the parking brake 9. In order to compensate for this, it is advantageous to provide a sensor 14 which is connected to the electric machine 2 or is part of the latter and detects such unwanted rolling. In this case, the electric drive of the electric machine 2 can be used. The electric drive is capable of generating a precisely defined countertorque in order to counteract this unwanted rolling.

A method for operating an electric vehicle according to the invention with a brake system which can be formed at the front axle 15 but just as easily also at the rear axle 16 from an operational perspective and which is described referring to FIGS. 1 and 2, comprises the following steps.

In order to start with the electric vehicle, the connection of the actuator 10 to the parking brake 9 is first canceled while the actuator 10 is still located in the securing region 11 in that the actuator 10 is moved from the securing region 11 into the neutral region 12 so that the axle is released and no longer acted on by braking torque. The electric vehicle can now be accelerated by rolling on an incline or the electric machine 2 generates a torque at the axle or, insofar as the axle is not driven, at another one of the axles of the electric vehicle.

If braking is carried out subsequently, for example, when stopping the electric vehicle, the actuator 10 is moved from the neutral region 12 into the service brake region 13 so that it enters into communication with the service brake 8, and the service brake 8 generates a braking torque at the axle. If the electric vehicle is to be parked after use, the electric vehicle which is now stationary is secured in that the actuator 10 is moved from the service brake region 13 through the neutral region 12 to the securing region 11 so that the actuator 10 enters into communication with the parking brake 9 and the axle is secured by positive engagement of the parking brake 9.

When the actuator 10 passes through the neutral region 12, the axle is temporarily unbraked so that an unwanted rolling of the electric vehicle may occur. This can advantageously be prevented by a further service brake 8 that cooperates when stopping the electric vehicle in that the further service brake 8 communicates with a further actuator 10 when stopping the electric vehicle, so that a braking action M is generated at the axle by the further service brake 8. The braking action M is maintained while the actuator 10 is moved from the service brake region 13 through the neutral region 12 to the securing region 11 as the electric vehicle is secured, and the axle is only released after the actuator 10 has entered into communication with the parking brake 9, so that the axle is secured by the parking brake 9. The axle is released by canceling the connection between the further actuator 10 and the further service brake 8 in that the further actuator 10 is moved from a further service brake region 13 into a further neutral region 12.

The further service brake 8 can also be part of a further brake system so that it is activated by a further actuator 10 which is located in a further service brake region 13, and a further parking brake 9 is activated after the axle is released in that it is moved to a further securing region 11 and enters into communication with the further parking brake 9. This is carried out after the axle has already been secured by the parking brake 9 and serves to additionally secure the axle. The actuators 10 of both brake systems are accordingly not moved simultaneously but rather one after the other into the respective securing region 11 so that the electric vehicle is at no time unbraked.

Exactly the same process can be employed in reverse in order to release the electric vehicle again after being completely secured by both brake systems without having to temporarily release the axle itself. Before the connection of the actuator 10 to the parking brake 9 is canceled, the further actuator 10 is then moved into the further service brake region 13 and enters into communication with the further service brake 8 so that the service brake 8 generates a braking action M at the axle and secures the latter. Subsequently, the connection of the actuator 10 to the parking brake 9 is canceled and the actuator 10 is moved away from the securing region 11 into the neutral region 12. When this has been accomplished, the connection of the further actuator 10 to the further service brake 8 is canceled in that it is moved from the further service brake region 13 into the further neutral region 12 so that the axle is released and an acceleration of the electric vehicle is enabled. Accordingly, the electric vehicle is not unbraked at any time in this case either and an unwanted rolling is prevented.

If an unwanted rolling of the electric vehicle comes about in spite of this procedure, for example, because no further service brake 8 is provided or because the latter is defective, the electric machine 2 can be engaged. This can be brought about by the above-described sensor 14, which detects such unwanted rolling during the cancellation of the connection of the actuator 10 to the parking brake 9. This can be accomplished optically, mechanically, or via motor currents. In order to prevent the unwanted rolling, the electric machine 2 generates a countertorque that acts on the axle and counteracts the unwanted rolling. The disengagement forces that occur when the connection of the actuator 10 to the parking brake 9 is canceled can also be compensated by a corresponding compensating torque generated by the electric machine 2.

In the examples described above, the respective brake systems are arranged in each instance in a separate brake housing 6. Alternatively, the service brake 8 and the parking brake 9 can also be installed along with the electric machine 2 together in a housing and can comprise a common oil supply.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-11. (canceled)

12. An electric vehicle comprising:
an axle; and
at least one brake system arranged at the axle and comprises:
a service brake configured as a frictionally engaging wet service brake;
a parking brake that is positively engaging; and
an actuator, wherein the actuator is adjustable between:
a service brake region within which the actuator communicates with the service brake,
a securing region within which the actuator communicates with the parking brake, and
a neutral region situated between the service brake region and the securing region within which the actuator communicates neither with the service brake nor with the parking brake.

13. The electric vehicle according to claim 12, wherein the at least one brake system is arranged between a differential and a transmission stage of the axle.

14. The electric vehicle according to claim 12, further comprising:
an electric machine communicating with the axle; and
a sensor configured to detect an unintended rolling of the electric vehicle when the actuator is located in the neutral region and, in response to the unintended rolling, a countertorque which opposes the unintended rolling is generated by the electric machine.

15. The electric vehicle according to claims 12, wherein the axle is a front axle and the electric vehicle further has a rear axle comprising in each instance exactly one brake system, and the two brake systems are arranged diagonally at the electric vehicle.

16. The electric vehicle according to claim 12, wherein the axle is a front axle and the electric vehicle further has a rear axle, wherein the front axle and the rear axle comprise in each instance exactly two brake systems.

17. A method for operating an electric vehicle comprising:
an electric vehicle with an axle is made available, wherein a brake system with a wet service brake that is frictionally engaging and a parking brake that is positively engaging are associated with the axle;
communicating by an actuator with the parking brake;
cancelling a connection of the actuator to the parking brake in that the actuator is moved from a securing region to a neutral region in which no braking torque acts on the axle allowing for acceleration of the electric vehicle;
moving the actuator from the neutral region into a service brake region and enters into communication with the wet service brake so that the wet service brake generates a braking torque at the axle to stop the electric vehicle; and
moving the actuator from the service brake region through the neutral region to the securing region and enters into communication with the parking brake so that the axle is secured by the parking brake, wherein the electric vehicle is secured.

18. The method for operating an electric vehicle according to claim 17, wherein a further wet service brake located at the axle further comprises:
communicating by a further actuator with the further wet service brake when stopping the electric vehicle, to generate a braking action at the axle by the further wet service brake;
maintaining the braking action by the further wet service brake while the actuator moves from the service brake region through the neutral region to the securing region with the electric vehicle secured;
cancelling connection of the further actuator to the further wet service brake by movement of the further actuator from a further service brake region into a further neutral region after the actuator has entered into communication with the parking brake, so that the axle is secured by the parking brake.

19. The method for operating an electric vehicle according to claim 18, wherein the further actuator is moved from the further service brake region to a further securing region during release of the axle and enters into communication with a further parking brake to secure the axle by the further parking brake.

20. The method for operating an electric vehicle according to claim 19, wherein the further actuator is moved into the further service brake region before cancellation of the connection of the actuator to the parking brake and enters into communication with the further wet service brake so that the further wet service brake generates a braking action at the axle and movement of the further actuator into the further neutral region after the actuator has been moved into the neutral region after cancellation of the connection between the actuator and the parking brake.

21. The method for operating an electric vehicle according to claim 20, wherein an unwanted rolling of the electric vehicle is detected during the cancellation of the connection of the actuator to the parking brake, and a countertorque is generated that acts on the axle and opposes the unwanted rolling.

22. The method for operating an electric vehicle according to claim 21, wherein a compensating torque is generated which acts on the axle and compensates a disengagement force which occurs when the connection of the actuator to the parking brake is canceled.
